(19) United States
(12) Patent Application Publication
(10) Pub. No.: US 2003/0105825 A1
(43) Pub. Date: Jun. 5, 2003

(54) Method and system for policy based management of messages for mobile data networks

(75) Inventors: Charles J. Kring, Sunnyvale, CA (US); Manthi Nguyen, Redwood City, CA (US); Cimarron Taylor, Oakland, CA (US); Gregory H. Barrault, Maisons-Laffitte (FR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Profluent, Inc., Sunnyvale, CA

(21) Appl. No.: 10/057,827

(22) Filed: Jan. 25, 2002

Related U.S. Application Data
(63) Continuation of application No. 09/847,520, filed on May 1, 2001.

(51) Int. Cl. G06F 15/16; G06F 15/173

(52) U.S. Cl. 709/206; 709/238

(57) ABSTRACT

A novel message policy manager and method for such manager. The manager includes a variety of modules such as a parsing module coupled to a data network. The parsing module is configured to identify information in the message. The manager also has a policy engine coupled to the parsing module, where the policy engine determines a processing decision for the message based upon the identified information from the parsing module. A storage module is coupled to the parsing module. The storage module is configured to store the message during a portion of time as the processing decision is performed. An enforcement module is coupled to the policy engine and is coupled to the storage module for performing the processing decision and providing an operation for delivery of the message to through the wireless network.

### CROSS-REFERENCE TO RELATED APPLICATIONS

This application is a continuation to U.S. Application Ser. No. 09/847,520 (Docket No.: 20995-000100US), filed May 1, 2001 commonly assigned, and hereby incorporated herein by reference for all purposes.

### BACKGROUND OF THE INVENTION

The present invention relates generally to managing data over mobile communication networks. More particularly, the invention provides a method and resulting system for managing messages to and from a mobile communication device over a wireless wide area network of computers. As merely an example, the invention is implemented in a mobile computing environment such as a cellular phone network. But it would be recognized that the invention has a much broader range of applicability. The invention can also be implemented in environments such as a local area computing environment, a satellite data service, wired wide area networks, and others.

Over the past few years, we have witnessed a dramatic shift in the way people communicate to each other at work and play. Millions of people now access information through a worldwide network of computers, commonly called the Internet, which couple these people together through computers. Such people exchanged messages among themselves locally or around the world through a personal computer connected through hard wires such as phone lines or cables. Personal computers have become relatively inexpensive and have found themselves in millions of homes and offices.

At about the same time, people also connected themselves onto mobile communication networks, which have also been connected to the Internet. As merely an example, cellular phones have become important companions for business and personal use. In many parts of the world that do not have conventional hardwired telephone networks, mobile communication network infrastructure has provided an inexpensive, easy to deploy alternative to such conventional infrastructures. Accordingly, messaging traffic has grown dramatically on the mobile communication networks.

Many products emerged to satisfy consumer demand. Examples of such products include, among others, SMS (Short Message Service), EMS (Enhanced Message Service), MMS (Multimedia Message Service), WAP (Wireless Application Protocol), Blackberry by Research In Motion Limited (“RIM”), and NTT DoCoMo's I-Mode services. As merely an example, users of the I-Mode service can exchange messages, purchase goods and services, and even make phone calls on their cellular phones, which have increased the amount of traffic on the network infrastructure. Much of this traffic has been borne by the conventional mobile infrastructure, despite upcoming potential deployment of next generation, high-speed networks. Additionally, it may take years for users to replace their current phones with handsets capable of interfacing with these new high-speed networks. In the meantime, users subscribed to messaging services over such mobile communication networks will generally suffer by delays in sending and receiving messages. Increased traffic will also cause complete network failures that will lead to even more message delays.

Even with the deployment of faster and faster networks, wireless networks still lack capacity to provide for future services. As data-enabled handsets replace existing handsets, even with faster networks in place, larger and larger files will be sent over the network. Here, the size of data files will generally increase by orders of magnitude. Conventional SMS messages are about 150 characters or so in size. Future applications for transmitting graphic files and transmitting streaming video will outstrip available and future bandwidth. Accordingly, users of the mobile communication networks will still suffer from drawbacks from increased types of information sent over the networks.

From the above, it is seen that an improved way of managing data over a mobile network is highly desirable.

### SUMMARY OF THE INVENTION

According to the present invention, techniques including methods and systems for managing messages (e.g., instant message, an alert such as stock or weather, MP-3 file, an e-mail message, an SMS message, an instant message, a chat message, a voice message, a video message, a picture, a map, an MP3, or a drawing) over a wide area network of mobile computing devices are provided. In an exemplary embodiment, the invention provides a novel way of processing and delivering messages from a source through a wireless network to a selected wireless communication device. The present invention provides an easy and efficient way of managing messages, which may be transparent to a user. Further details of the invention are provided throughout the present specification and more particularly below.

In a specific embodiment, the invention provides a method for receiving, processing, and delivering one or more messages for distribution over wireless networks. The method includes receiving a message from a data network to a policy manager coupled between the data network and a wireless network. The method also parses the message to identify selected information (e.g., priority, delivery time, validity period, sender, receiver, data in the message body or headers) in the message for delivery of that message to a wireless client device of a selected user. The method determines a processing decision (e.g., delete message, hold message, forward message, replace message) for the message based upon at least the selected information and predetermined information (e.g., time of day, type of message, expected traffic, message queue length) of the policy manager while storing the message during a portion of time as the processing decision is determined. A step of performing the processing decision for delivery of the message through the wireless network to the wireless client device is included. Alternatively, the method can be deployed within any portion of a wireless network and does not need to be coupled to a data network in other embodiments.

In an alternative specific embodiment, the invention provides a novel system for policy-based management of messages over wireless networks, e.g., SMS, EMS, MMS, SMTP. The system has a data network (e.g., wired network, wired telephone network, wireless data networks), which has a source of messages. The system also has a wireless network, which has a destination for the messages. A policy manager is coupled to the wireless network on one side and to the data network on the other side. Alternatively, the system can be deployed within any portion of a wireless network and does not need to be coupled to a data network in other embodiments. The policy manager is configured between the source of messages on the data network and the destination for the messages on the wireless network. The policy manager is capable of selecting one of the messages and making a decision based upon a processing operation for delivery of the selected message to the wireless network. The processing operation can be procedural information such as how, when, etc. the message will be delivered. Alternatively, the procedural information can include other parameters such as protocol, application type, network destination, filtering, and priority.

In still a further embodiment, the invention provides a novel message policy manager apparatus. The policy manager includes a variety of modules such as a parsing module coupled to a data network, which is a source of messages. The parsing module is configured to identify information in the message. The information includes time to deliver, validity period, priority, sender, and receiver. The policy manager also has a policy engine coupled to the parsing module, where the policy engine determines a processing decision for the message based upon the identified information from the parsing module. A storage module is coupled to the parsing module. The storage module is configured to store the message during a portion of time as the processing decision is performed. In a preferred embodiment, the storage module is a cache device for temporarily storing the message. An enforcement module is coupled to the policy engine. The enforcement module is also coupled to the storage module. The enforcement module performs the processing decision from the policy engine and also provides an operation for delivery of the message through the wireless network.

Many benefits are achieved by way of the present invention over conventional techniques. For example, the present invention provides an easy to use process and system that relies upon conventional technology. Additionally, the invention allows for many different types of networks (e.g., SS7, Ethernet, ATM, X.25, SONET, Frame Relay) that can be coupled to modules defined herein. The invention also provides for a system and method that can be scaled up to transfer larger and larger numbers of messages. Another benefit would be the invention prioritizes a delivery of the messages to let the more important messages come through first. Some messages can be filtered in order to limit unwanted ones like a spamming filter or a virus filter. The messages can be delivered according to a user defined schedule. This invention can enhance the overall quality of service by grouping the messages for a user and sending them within the same connection. A policy engine ensures that service is delivered according to how service works. Scheduled delivery, opportunistic rate delivery of bulk rate data are also included. Depending upon the embodiment, one or more of these benefits may be achieved. These and other benefits will be described in more throughout the present specification and more particularly below.

Various additional objects, features and advantages of the present invention can be more fully appreciated with reference to the detailed description and accompanying drawings that follow.

### BRIEF DESCRIPTION OF THE DRAWINGS

FIG. 1 is a simplified diagram of a mobile wireless system according to an embodiment of the present invention;

FIG. 1A is a simplified diagram of a mobile wireless system according to an alternative embodiment of the present invention;

FIG. 1B is a simplified diagram of a mobile wireless system according to an alternative embodiment of the present invention;

FIG. 2 is a simplified diagram of message policy management system architecture according to an embodiment of the present invention;

FIG. 3 is a simplified diagram of system software according to an embodiment of the present invention;

FIG. 4 is a simplified flow diagram of methods at an input handler according to embodiments of the present invention;

FIG. 5 is a simplified flow diagram of methods at an output handler according to embodiments of the present invention;

FIG. 6 is a simplified flow diagram of methods at a classifier according to embodiments of the present invention;

FIG. 7 is a simplified flow diagram of methods at a decision support module according to embodiments of the present invention; and

FIG. 8 is a simplified flow diagram of methods at a policy decision point according to embodiments of the present invention.

### DESCRIPTION OF THE SPECIFIC EMBODIMENTS

The present invention relates generally to managing data over mobile communication networks. More particularly, the invention provides a method and system for managing messages to and from a mobile communication device over a wide area network of computers. As merely an example, the invention is implemented in a mobile computing environment such as a cellular phone network, e.g., GSM, CDMA, GPRS, EDGE, TDMA, CDMA2000, WCDMA, IMT2000, Mobitex, CDPD, Datatek, Paknet, and Ardis. But it would be recognized that the invention has a much broader range of applicability such as any network with a limited ‘last mile’, any network that directs messages into a mobile network.

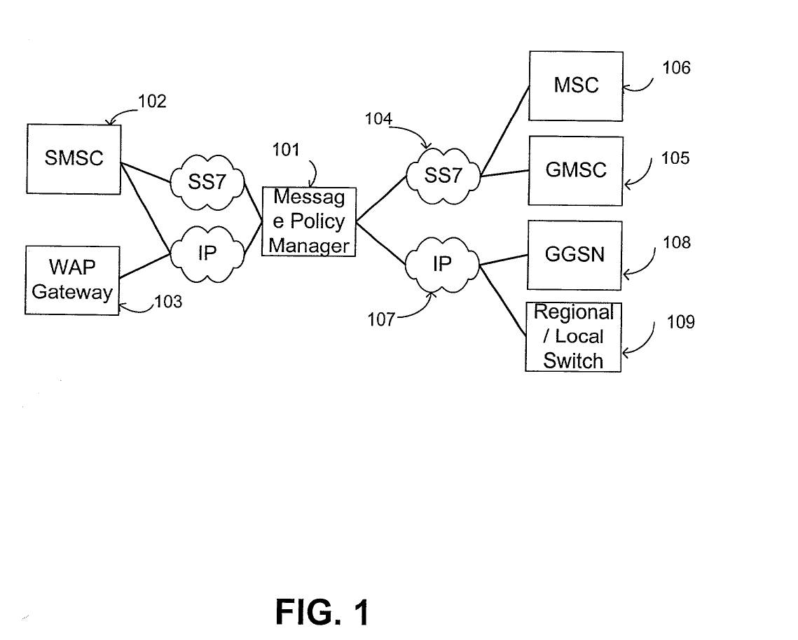

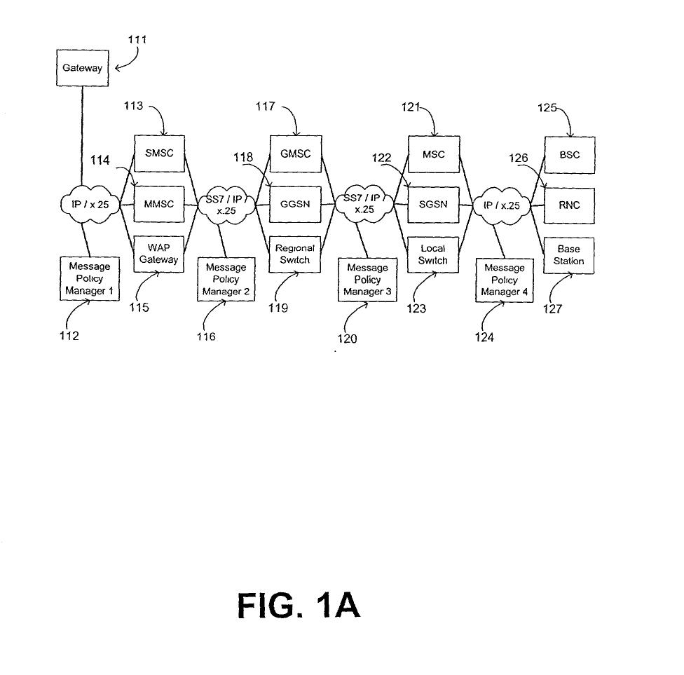

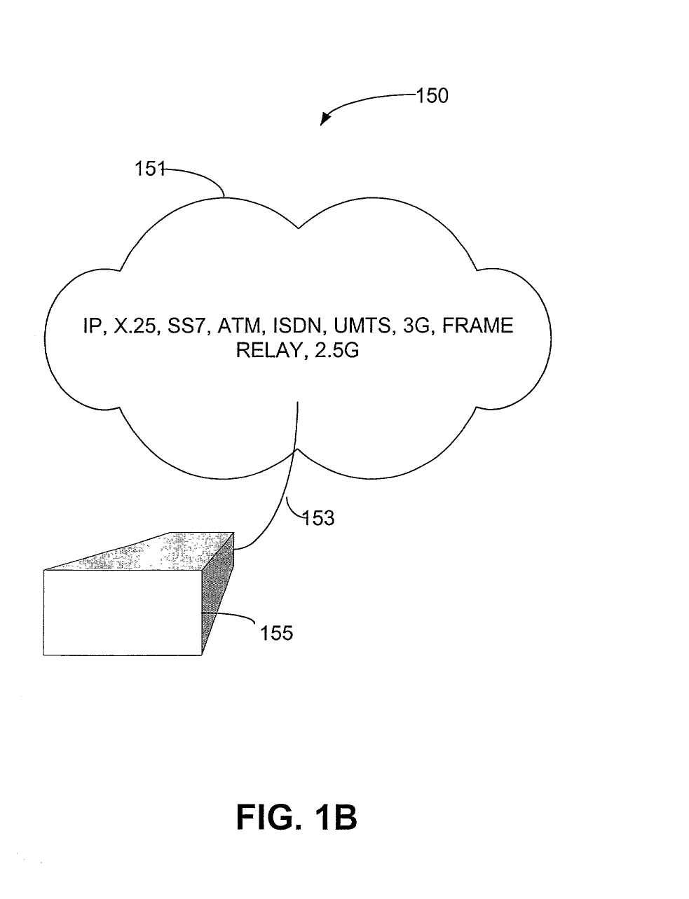

FIG. 1 is a simplified diagram of a mobile wireless system according to an embodiment of the present invention. This diagram is merely an example that should not unduly limit the invention defined by the claims herein. One of ordinary skill in the art would recognize many other variations, modifications, and alternatives. As shown, the system includes a variety of elements such as policy manager 101, which is coupled to a carrier's network. As merely an example, the policy manager is inserted into a carrier's network between Short Messaging Service Carrier (“SMSC”) 102 and Wireless Application Protocol (“WAP”) gateways 103. Alternatively, the policy manager can be coupled to the SMSC or to the WAP Gateway. The policy manager is also coupled to gateway routers into a wireless data network.

In a specific embodiment, the message policy manager interfaces to each of the elements noted using common protocols. In a preferred embodiment, the policy manager uses an SS7 protocol 104 with a Gateway Mobile Switching Center (“GMSC”) 105 to send short messages over a wireless network, i.e., GSM, CDMA, and using an IP protocol 107 to interface with a Gateway Mobile Switching Center(“GGSN”) 108 to send messages over a 2+G network (e.g., GPRS, EDGE, 3G). Alternatively, the policy manager uses IP protocol 107 to interface with a regional switch 109 to send messages over a pager network such as Mobitex, but is not limited to such network or protocol. In other embodiments, the message policy manager connects to other types of gateways such as other types of gateway routers as well as accepts messages from other types of message gateways. One of ordinary skill in the art would recognize many other variations, alternatives, and modifications.

FIG. 1A is a simplified diagram of a system according to an alternative embodiment of the present invention. This diagram is merely an example that should not unduly limit the invention defined by the claims herein. One of ordinary skill in the art would recognize many other variations, modifications, and alternatives. As shown, the system 110 includes multiple network elements used in the messages delivery process. Various types of networks are crossed, such as IP, x.25 or SS7 or others. The system 112 is coupled to or connected to any interworking server that is able to interact with these elements, e.g. Multimedia Message Service Relay (MMS Relay), Multimedia Message Service Center 114 (MMSC), Short Message Service Center 113 (SMSC), Wireless Application Protocol Gateway 115 (WAP Gateway), Unstructured Supplementary Services Data (USSD).

A message policy manager 116 is connected to a network, which can be IP or x.25 or SS7 or others. It can be deployed into a data center. It can also be deployed between the Service Centers 113, 114, 115 and a Wireless Network 117, 118, 119, into the Core Network of a Wireless Network 120 and into the Base Station Subsystem of a Wireless Network 124 The system can be integrated in any of the previous network elements, such as: Short Message Service Center 113 (SMSC), Multimedia Message Service Center 114 (MMSC), Wireless Application Protocol Gateway 115 (WAP Gateway), Gateway Mobile Switching Center 117 (GMSC), Gateway GPRS Support Node 118 (GGSN), Regional Switch 119, Mobile Switching Center 121 (MSC), Serving GPRS Support Node 122 (SGSN), Local Switch 123, Base Station Controller 125 (BSC), Radio Network Controller 126 (RNC), Base Station 127. FIG. 1B is a simplified diagram of a mobile wireless system 150 according to an alternative embodiment of the present invention. This diagram is merely an example that should not unduly limit the invention defined by the claims herein. One of ordinary skill in the art would recognize many other variations, modifications, and alternatives. As shown, the system 150 includes a wireless cloud, which can be a variety of networks such as IP, x.25, SS7, ATM, ISDN, UMTS, 3G, Frame Replay, 2.5 G, and others. Such networks can be coupled to each other or be standalone. Such networks can be wireless and/or wired. The present system includes a policy manager 155 which is coupled through line 153 but can also be wireless. Further details of the policy manager are provided below.

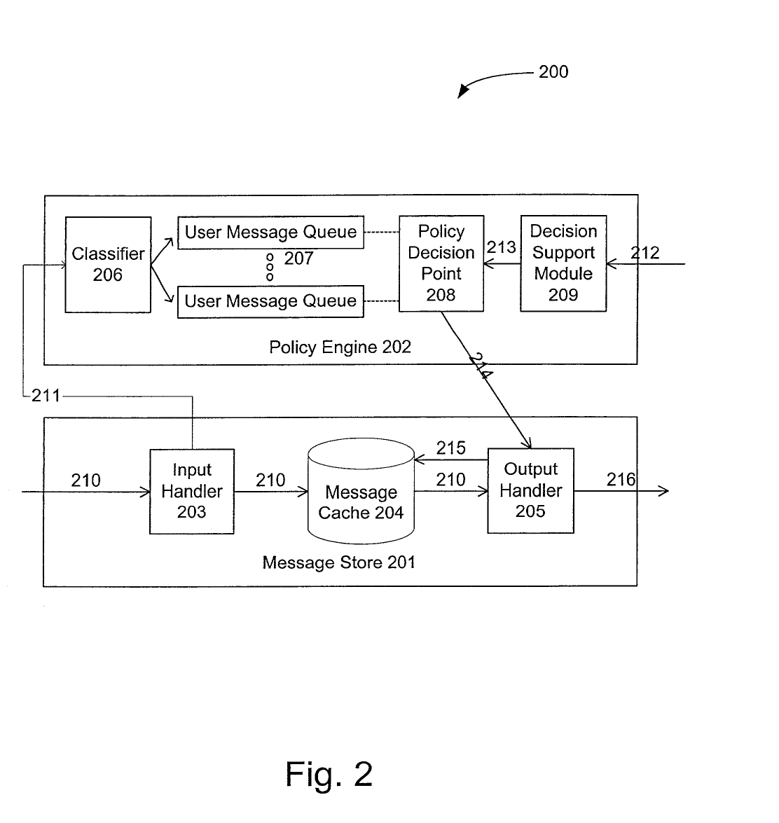

FIG. 2 is a simplified diagram of message policy management system 200 according to an embodiment of the present invention. This diagram is merely an example that should not unduly limit the invention defined by the claims herein. One of ordinary skill in the art would recognize many other variations, modifications, and alternatives. As shown, the message policy manager has a variety of elements such as a message store 201 and a policy engine 202. In a specific embodiment, the message store includes one or more input handlers 203, a message cache 204, and one or more output handlers 205. The policy engine 202 has a classifier 206, one or more message queues 207, a policy decision point 208, and a decision support module 209. Depending upon the embodiment, there can also be other elements.

In one embodiment, the policy manager performs in a selected manner to monitor and process messages. In a specific embodiment, incoming messages 210 are received by the input handler 203, which is coupled to a source of messages. The source of messages can be a network or the like. The messages are parsed to generate metadata 211 such as the name of user the message is addressed to, delivery criteria such as message criticality or expiration date, the address of the entity that sent the message, or information about the content of the message. Message metadata also contain an identification of what message store 201 contains the message and a way for identifying the message in that message store's message cache 204. As merely an example, metadata can be provided as follows:

TABLE
Meta data

| Field name | Example | Description |
|---|---|---|
| Msg_id | 789564132459875465 | Unique message |
| | | identifer |
| Msg_cache_id | 456987156548462474 | Unique identifer |
| | | used to retrieve |
| | | one message data |
| | | from the Message |
| | | Cache |
| Source_addr | 4087891254 | Address of the |
| | | message originator |
| Source_npi | 024 | Numbering plan |
| | | indicator for |
| | | source address |
| Destination_addr | 4086543256 | Address of the |
| | | message destination |
| Destination_npi | 045 | Numbering plan |
| | | indicator for |
| | | destination address |
| Protocol_id | 843 | Protocol identifier |
| Priority_flag | 5 | Designates the |
| | | priority of the |
| | | message |
| Schedule_delivey_time | 13:00:00 | Time to send the |
| | | message |
| Reception_time | 09:48:46 | Time the message |
| | | was received |
| Latest_delivey_time | 09:58:46 | If the message is |
| | | not sent before |
| | | this time, discard |
| | | it or send a |
| | | response back |
| Acknowledgement | 1 | The outcome of the |
| | | message forwarding |
| | | has to be |
| | | acknowledged |
| Validity_period | 063020021200 | Date and time until |
| | | the message is no |
| | | longer valid |
| Replace_if_present_flag | 1 | Flag indocating if |
| | | submitted message |
| | | should replace an |
| | | existing message |
| Data_coding | 123 | Defines the |
| | | encoding scheme of |
| | | the message |
| Sequence_number | 0003 | Indicates this |
| | | message is part of |
| | | a group of messages |
| Criticality | 4 | The sensitiveness |
| | | of the message |

As shown, the metadata table includes field name, example, and description. Next, the input handler 203 sends the message 210 to the message cache 204 and the metadata 211 to the policy engine 202 for processing. The message cache temporarily stores the message for a selected period of time, until the message is ready to be routed, canceled, or processed in another manner based upon the instructions from the policy engine.

The classifier 206 in the policy engine 202 assigns message metadata into a user message queue 206 based upon the user that the message is addressed to. Alternatively, the message queues can be identified according to a service. Alternatively, the message queues can be identified according to any combination of these as well as other parameters. The user message queue can be for one of a plurality of users. As merely an example, message queues can be identified according to users as follows:

| User Message | |
|---|---|
| Queue Number | User Name |
| 1 | Chuck Kring |
| 2 | Richard Ogawa |
| 3 | Bob Smith |
| . | |
| . | |
| . | |
| n | Mr. N |

As noted above and as merely an example, message queues can be identified according to service as follows:

| Service | |
|---|---|
| Queue Number | Service |
| 1 | Instant Message |
| 2 | Voice Mail |
| 3 | Electronic Mail |
| 4 | Ringtones |
| 5 | MP3 |
| 6 | Picture messaging |
| 7 | moving images |
| 6 | network games |
| 7 | interactive video |
| | (videoconference, telemedicine, |
| | telelearning) |
| . | |
| . | |
| . | |
| n | Other |

Policy decision point 208 receives policy decision support information 213 from the decision support module 209 based upon external information 212 submitted to the decision support module. The external information can be based upon a network status, user preferences, or other criteria for deciding how and/or when messages should be processed. Other examples of external information have been provided below, but are not intended to be limiting in any manner.

### External Network Information or Status

Traffic level

Device connected

Memory full

Device busy

Roaming in another network

Radio interface overload

Error reports

No response

System failure

Invalid response

The decision support information 213 can also be derived from internal information 209 generated from the policy decision point 208. As merely an example, internal information can include, but is not limited to the following.

### Internal Network Information or Status

Waiting for more messages

SLA of a user or group of users

SLA of sender

Max time before delivery

Time of the day

Queue length

When the policy decision point determines that the message should be processed, it sends a process message request 214 to output handler 205. The output handler requests 215 the message 210 from the data cache 204, processes the message, then outputs the processed message 216 to the wireless network. The following may be an example of functionality describing some of the above processes.

There are three (3) SMS for the user, Mr. Chuck Kring, waiting to be delivered. Mr. Kring is connected to the network through a mobile phone. His phone is turned on and he is in a covered area, which is capable of receiving and sending wireless information. The messages could have been delivered. But due to congestion in the network, because of extensive voice calls, the decision support module did not allow the policy decision point to deliver the three messages. The decision support module allowed the policy decision point to deliver one message. The policy decision module is to select one of the most important messages to send: the first one is a stock quote alert, the second one is an email and the third one is weather alert. The policy decision module decides to forward the most important message to Mr. Kring. A command is then sent to the output handler to deliver the second message (the email) to Mr. Kring by providing its message cache identifier.

The above system can be implemented in computer software and/or hardware. Details of such system are provided more fully below.

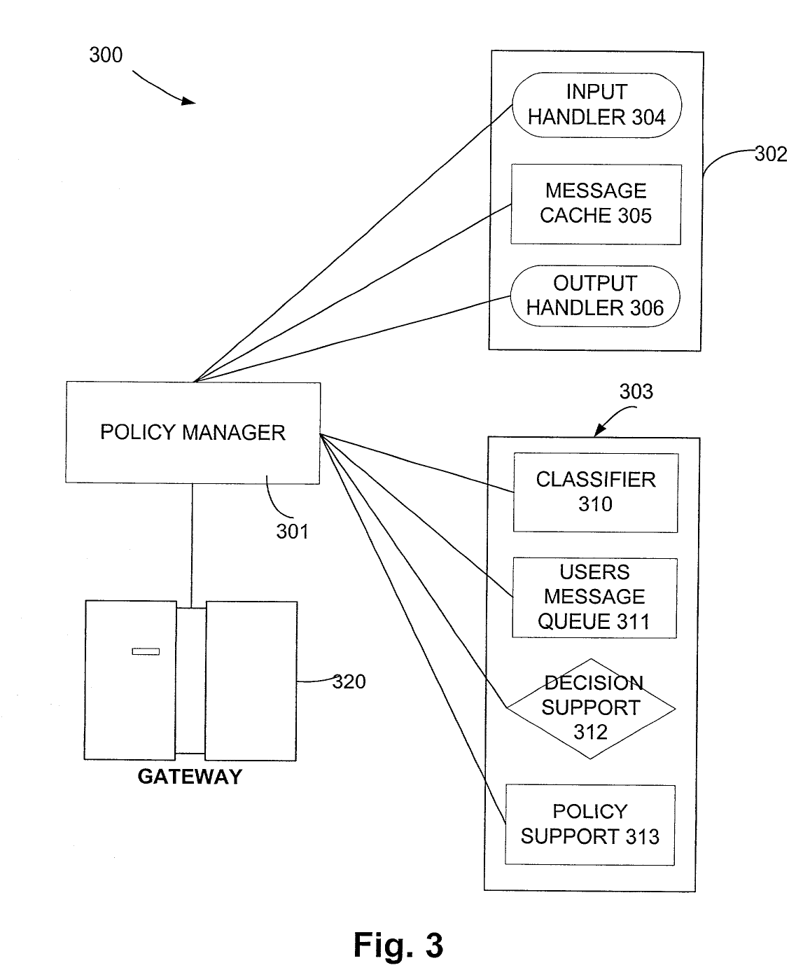

FIG. 3 is a simplified diagram of system software 300 according to an embodiment of the present invention. This diagram is merely an example that should not unduly limit the invention defined by the claims herein. One of ordinary skill in the art would recognize many other variations, modifications, and alternatives. As shown, the system diagram 300 includes a variety of processes or modules, which are each coupled together, but can also operate independently, in some cases. As shown, the message policy manager 301 has a variety of elements such as a message store 302 and a policy engine 303. In a specific embodiment, the message store includes one or more input handlers 304, a message cache 305, and one or more output handlers 306. The policy engine has one classifier 310, one or more message queues 311, a policy decision point 312, and a decision support module 313.

The above figures describe aspects of the invention illustrated by elements in simplified system diagrams. As will be understood by one of ordinary skill in the art, the elements can be implemented in computer software. The elements can also be implemented in computer hardware. Alternatively, the elements can be implemented in a combination of computer hardware and software. Some of the elements may be integrated with other software and/or hardware, or specialized hardware (e.g. an ASIC). Alternatively, some of the elements may be combined together or even separated. These and other variations, modifications, and alternatives will be apparent by one of ordinary skill in the art. Further details of methods according to embodiments of the present invention can be found throughout the present specification and more particularly below. Additionally, some details of some of the modules are also provided below.

In a specific embodiment, the message cache performs a variety of functions. Such functions can include, among others, store, retrieve, remove, replace, and update. The message cache can be a database, file, and/or any suitable memory. The memory has suitable storage size and speed to carry out aspects of the present invention. Of course, one of ordinary skill in the art would recognize many other variations, modifications, and alternatives. In the specific case of handling Short Messages, a message may not be cached. The data of the short message would be part of the metadata.

In a specific embodiment, the queues order the data in a predefined manner. The queues can be based upon user, service, or other parameter. The queues can perform a variety of functions. Such functions include prioritize one or more messages. They also include functions to delay a message. Here, the delay is added to a message. Other functions include ordering, discarding, and queuing one or more messages. The functions of the queues are to hold data for the next process in a predetermined manner. Each of the queues performs such functions in an independent manner from the policy decision point. Of course, one of ordinary skill in the art would recognize many other variations, modifications, and alternatives. Further details of some of the other modules are provided below according to the FIGS.

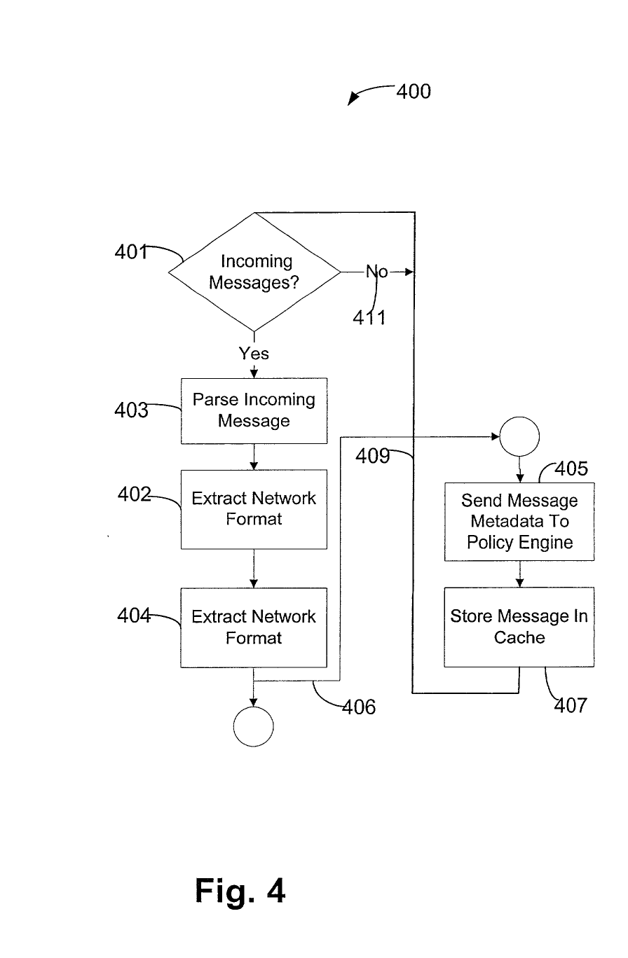

FIGS. 4 to 8 show details of the methods according to embodiments of the present invention. These diagrams are merely examples that should not unduly limit the invention defined by the claims herein. One of ordinary skill in the art would recognize many other variations, modifications, and alternatives. Depending upon the embodiment, some of these methods can be combined with each other. Some of these methods may be separated. Additionally, some of these methods may be performed concurrently or alternatively, they can be performed in serial or parallel manner. Further details of these methods are provided throughout the specification and more particularly below. FIG. 4 shows a method at an input handler according to an embodiment of the present invention. Such method can be outlined as follows

1. Check for incoming messages from an Input Handler, which is coupled to a network;

2. If messages have been received, parse the incoming messages, alternatively if no messages have been detected test the network using the test method, which has been described below;

3. Send message metadata to policy engine;

4. Store message in cache;

5. Return to step (1); and/or

6. Perform other steps, as desired.

The above sequence of steps is merely an example of a way to carry out the present invention. As shown, these steps provide a way of processing messages from an incoming handler and then distributing one or more portions of the message for further processing. After that, the method goes on to perform the same or other steps. One of these steps would be to transfer the message to a selected mobile communication device through a wireless network. Further details of these steps are provided throughout the present specification and more particularly below.

Referring to FIG. 4, the present method 400 begins by determining if there is an incoming message, step 401. The incoming message is derived from a message source. The message source can be received or selected from a server, such as a SMSC, and others. If a message has been received, the method parses the incoming message, step 403. In a specific embodiment, the method extracts (step 402 ) a network format from the message. Here, the network format can be include SS7, x.25, SMPP (short message peer to peer), and others. As merely an example the following SMS message is received.

```
    917238010010
07
    F5
```

040BC87238880900F100009930925161958003
C16010

As when shown, the message is delivered as an atomic unit by itself. The message is parsed as follows:

TABLE
Parsed Message

| Octet(s) | Description |
|---|---|
| 07 | Length of the SMSC information (in this case |
| | 7 octets) |
| 91 | type of address of the SMSC. (91 means |
| | international format of the phone number) |
| 72 38 01 00 10 F5 | Service center number (in decimal semi- |
| | octets). The length of the phone number is |
| | odd (11), so a trailing F has been added to |
| | form proper octets. The phone number of this |
| | service center is “+27381000015”. |
| 04 | First octet of this SMS-DELIVER message. |
| 0B | Address-Length. Length of the sender number |
| | (0B hex = 11 dec) |
| C8 | type of address of the sender number |
| 72 38 88 09 00 F1 | Sender number (decimal semi-octets), with a |
| | trailing F |
| 00 | TP-PID. Protocol identifier |
| 00 | TP-DCS data coding scheme |
| 99 30 92 51 61 95 80 | TP-SCTS. Time stamp (semi-octets) |
| 0A | TP-UDL. User data length, length of message. |
| | The TP-DCS field indicated 7-bit data, so the |
| | length here is the number of septets (10). |
| E8329BFD4697D9EC37 | TP-UD. Message ‘hello hello’, 8-bit octets |
| | representing 7-bit data. |

As shown, the parsed message separates the message into logical elements. These elements include the service center originating the message (SMSC), the sender address, the data coding scheme of the message, the time-stamp, the message, etc. Next, the method generates message meta data (which are the internal data format). The message meta data are then transferred to a policy engine, step 405. The policy engine can be similar to the one described above but can also be another. The data of the message may be included in the meta data. Using the above example, the following information is transferred to the policy engine.

TABLE
Information Transferred to Policy Engine

| Octet(s) | Description |
|---|---|
| 07 | Length of the SMSC information (in this case 7 |
| | octets) |
| 91 | type of address of the SMSC. (91 means |
| | international format of the phone number) |
| 72 38 01 00 10 F5 | Service center number (in decimal semi-octets). |
| | The length of the phone number is odd (11), so |
| | a trailing F has been added to form proper |
| | octets. The phone number of this service center |
| | is “+27381000015”. See below. |
| 04 | First octet of this SMS-DELIVER message. |
| 0B | Address-Length. Length of the sender number |
| | (0B hex = 11 dec) |
| C8 | type of address of the sender number |
| 72 38 88 09 00 F1 | Sender number (decimal semi-octets), with a |
| | trailing F |
| 00 | TP-PID. Protocol identifier. |
| 00 | TP-DCS data coding scheme |
| 99 30 92 51 61 95 80 | TP-SCTS. Time stamp (semi-octets) |
| 456987156548462474 | Msg_cache_id |

Next, the method stores the message into cache, step 407. As shown, the cache can be similar to the one described above but can be others.. As merely an example, the following information is stored in cache.

TABLE
Information Stored in Cache

| Octet(s) | Description |
|---|---|
| 456987156548462474 | Msg_cache_id |
| | Length of the SMSC information (in this case |
| | 7 octets) |
| 91 | type of address of the SMSC. (91 means |
| | international format of the phone number) |
| 72 38 01 00 10 F5 | Service center number (in decimal semi- |
| | octets). The length of the phone number is |
| | odd (11), so a trailing F has been added to |
| | form proper octets. The phone number of this |
| | service center is “+27381000015” See below. |
| 04 | First octet of this SMS-DELIVER message. |
| 0B | Address-Length. Length of the sender number |
| | (0B hex = 11 dec) |
| C8 | type of address of the sender number |
| 72 38 88 09 00 F1 | Sender number (decimal semi-octets), with a |
| | trailing F |
| 00 | TP-PID. Protocol identifier. |
| 00 | TP-DCS data coding scheme |
| 99 30 92 51 61 95 80 | TP-SCTS. Time stamp (semi-octets) |
| 0A | TP-UDL. User data length, length of message. |
| | The TP-DCS field indicated 7-bit data, so the |
| | length here is the number of septets (10). If |
| | the TP-DCS field were set to indicate 8-bit |
| | data or Unicode, the length would be the |
| | number of octets (9). |
| E8329BFD4697D9EC37 | TP-UD. Message ‘hello hello’, 8-bit octets |
| | representing 7-bit data. |

Alternatively, if there are no incoming messages, the method goes back (step 411 ) to the decision step 401, where the method continues to operate along the sequence noted above through branch 409.

The above figure describes aspects of the invention illustrated by elements in a simplified flow diagram. As will be understood by one of ordinary skill in the art, the elements can be implemented other ways. The method is preferably implemented in computer software. The elements can also be implemented in computer hardware. Alternatively, the elements can be implemented in a combination of computer hardware and software. Some of the elements may be integrated with other software and/or hardware, or specialized hardware (e.g. an ASIC). Alternatively, some of the elements may be combined together or even separated. These and other variations, modifications, and alternatives will be apparent by one of ordinary skill in the art. Further details of methods according to embodiments of the present invention can be found throughout the present specification and more particularly below.

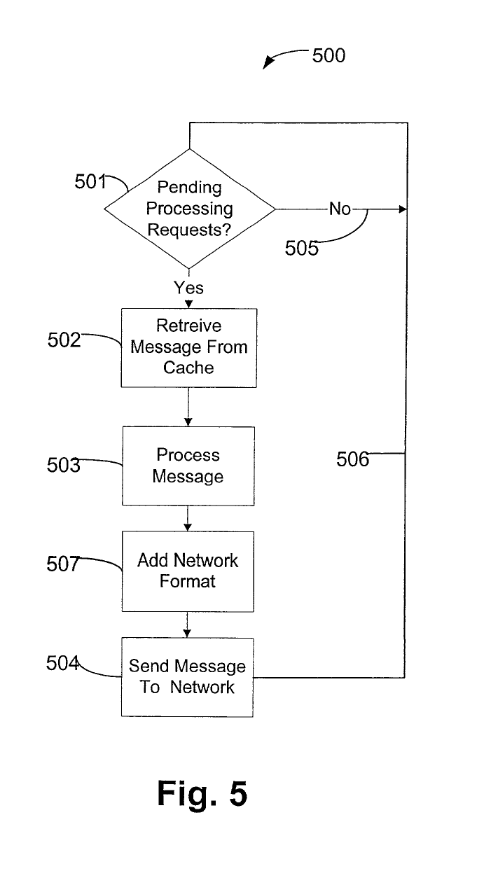

FIG. 5 shows a method at an output handler according to an embodiment of the present invention. Such method may be outlined as follows:

1. Determine if there are pending process requests;

2. If there are pending process requests, continue to next step, alternatively, return to step (1);

3. Retrieve message from cache;

4. Process message based upon selected criteria;

5. Send message to network; and/or

6. Perform other steps, as desired.

The above sequence of steps is merely an example of a way to carry out the present invention. As shown, these steps provide a way of processing pending message requests that have been stored in cache. The message is processed and then transferred to a user on the network. After that, the method goes on to perform other steps. One of these steps would be to transfer the message to a selected mobile communication device through a wireless network. Further details of these steps are provided throughout the present specification and more particularly below.

Referring to FIG. 5, the present method of processing requests illustrated by the flow diagram of reference numeral 500. As noted, this diagram is merely an example and should not unduly limit the scope of the claims herein. The method begins by determining if there are processing requests, step 501. If so, the method retrieves a message from cache, step 503. As merely an example, the following messages retrieve for cache.

```
    917238010010
07
    F5
```

040BC87238880900F100009930925161958003
C16010

In a specific embodiment, the method processes the message, step 503. The process can be selected from one or more rules. As an example one rule could be to format the data according to the output protocol. Such output protocol can include a parameter to send more messages. The parameter “More-Messages-to-Send” might have to be modified according to the total number of messages to be sent at once. If multiple messages have to be sent sequentially to the same user, the messages may be sent through the same connection. By indicating that more messages are to be sent, the method will maintain an open connection between the output handler and client device. Other examples of processing can include changing the message to a format that is acceptable by the wireless network. For example, the message may be processed in the manager in a first format. The wireless network requires a second format such as MAP, TCAP, IP, x-25, SS7, and others.

Once the message has been processed, the method add a network format to it, step 506. The network format can include SST, x.25, SMPP, and others. Now, the message is ready to be sent to over the network. The method goes on to step 504, which sends the message from the message cache through the output handler. The output handler transfers the message to a mobile user device through a wireless network. Next, the method returns to step 501 via branch 506.

The above figure describes aspects of the invention illustrated by elements in a simplified flow diagram. As will be understood by one of ordinary skill in the art, the elements can be implemented other ways. The method is preferably implemented in computer software. The elements can also be implemented in computer hardware. Alternatively, the elements can be implemented in a combination of computer hardware and software. Some of the elements may be integrated with other software and/or hardware, or specialized hardware (e.g. an ASIC). Alternatively, some of the elements may be combined together or even separated. These and other variations, modifications, and alternatives will be apparent by one of ordinary skill in the art. Further details of methods according to embodiments of the present invention can be found throughout the present specification and more particularly below.

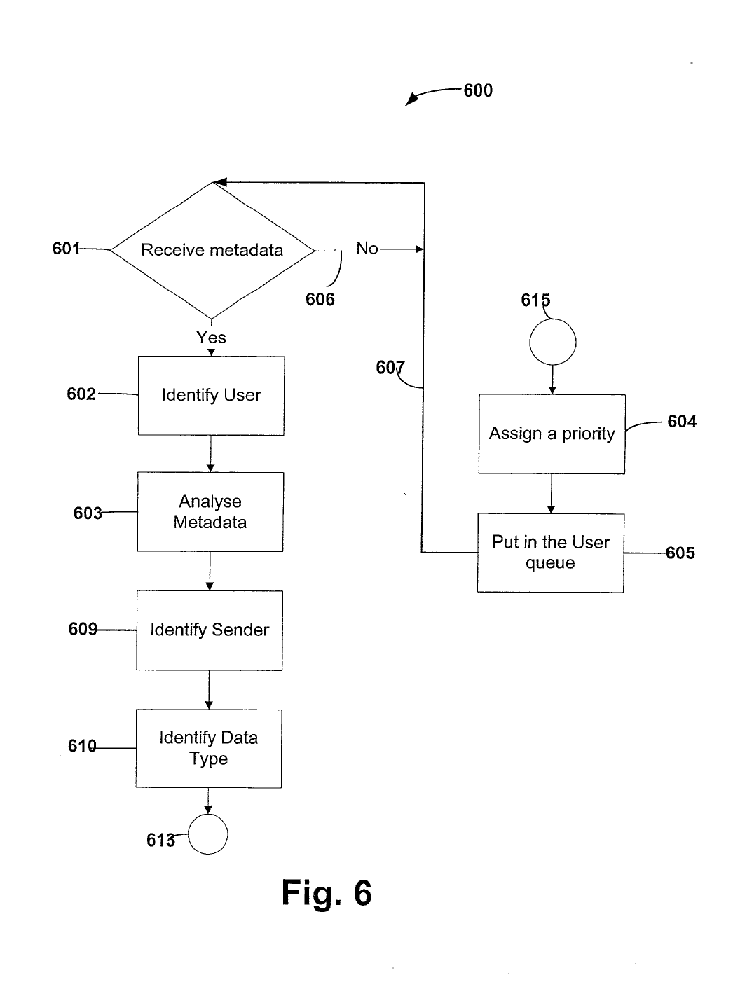

FIG. 6 shows classifier according to an embodiment of the present invention. Such classifier method may be outlined as follows:

1. Determine if there are pending process requests;

2. If there are pending process requests, continue to next step, alternatively, return to step (1);

3. Identify the user in the metadata and retrieve it's information (preferences, localization);

4. Analyze the metadata, add more data (like a time stamp);

5. Put the metadata in the message queue.

The above sequence of steps is merely an example of a way to carry out the present invention. As shown, these steps provide a way of testing and processing pending message requests. In some embodiments, depending upon the status of the network, messages are processed accordingly. After that, the method goes on to perform other steps. One of these steps would be to transfer the message to a selected mobile communication device through a wireless network. Further details of these steps are provided throughout the present specification and more particularly below.

Referring to FIG. 6, the present method provides a simplified flow diagram (600) to illustrate a process of testing a network. As noted, this diagram is merely an example, which should not unduly limit the scope of the claims defined herein. The method begins at a process operation shown by reference numeral 601. The method tests presence of pending requests. If not, the method continues through branch 606 back to the element identified by reference numeral 601. Alternatively, the method goes onto step 602. Here, the method identifies the user and retrieve all the available information concerning this user. As shown below, we provide a list of users information.

### Brief List of User Information

User service level agreement;

Ability to receive SMS, EMS, MMS, etc.;

User preferences;

User connected;

Position in the network.

The users information can also comprise much more information in addition to the information provided above. In a specific embodiment, the method retrieves user information from a database 608 or other information or knowledge source, which is coupled to step 602. The method can also identify other information as shown in steps 609, 610. The method identifies sender information, step 609. Here, the method can query a database 608 or other information or knowledge source. The method can also identify data type based upon predetermined information. Such predetermined information can be found in a database or other information or knowledge source. Next, the method analyze the metadata itself, step 603. It will also add more data like a time stamp to track the time a message spend in the queues. Some of these processing operations depend upon the status of the network and the time of day among other factors. Once the processing operation has been done, the metadata are added to the user queue 605. Then the entire method starts again via branch 607. These and other steps can be provided in the present method, which can be combined with any one or more of the methods described herein as well as others.

The above figure describes aspects of the invention illustrated by elements in a simplified flow diagram. As will be understood by one of ordinary skill in the art, the elements can be implemented other ways. The method is preferably implemented in computer software. The elements can also be implemented in computer hardware. Alternatively, the elements can be implemented in a combination of computer hardware and software. Some of the elements may be integrated with other software and/or hardware, or specialized hardware (e.g. an ASIC). Alternatively, some of the elements may be combined together or even separated. These and other variations, modifications, and alternatives will be apparent by one of ordinary skill in the art.

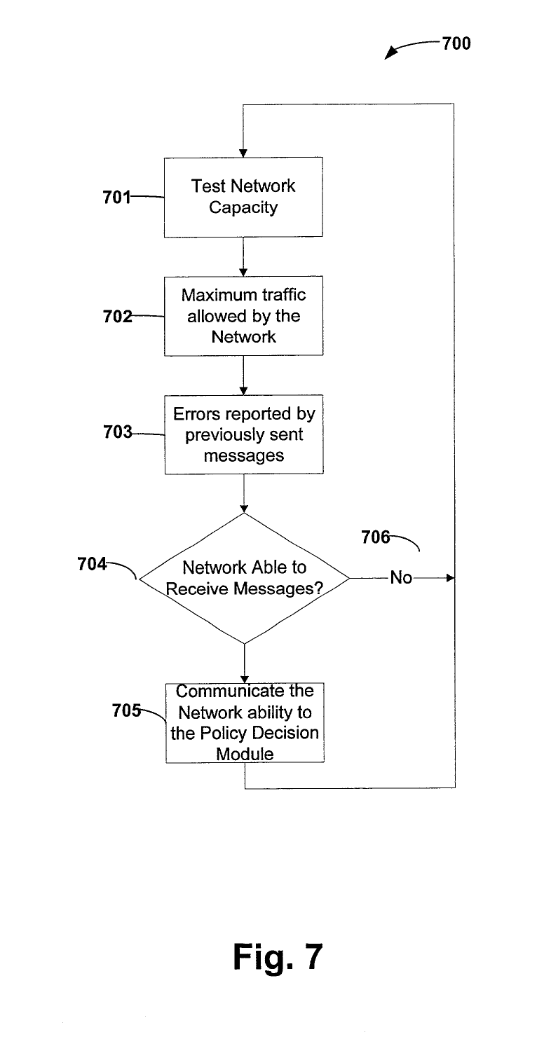

FIG. 7 shows a test method according to an embodiment of the present invention. Such method may be outlined as follows:

1. Test network capacity using one or more predetermined test processes;

2. Verify the network capacity does not exceed the maximum allowed;

3. Adapt the capacity to the reported errors from the previous messages sent;

4. Determine if the network is able to receive messages;

5.

6. Communicate the network capacity to the Policy Decision Module.

The above sequence of steps is merely an example of a way to carry out the present invention. As shown, these steps provide a way of testing and processing pending message requests. In some embodiments, depending upon the status of the network, messages are processed accordingly. After that, the method goes on to perform other steps. One of these steps would be to transfer the message to a selected mobile communication device through a wireless network. Further details of these steps are provided throughout the present specification and more particularly below.

Referring to FIG. 7, the present method provides a simplified flow diagram (700) to illustrate a process of testing a network. As noted, this diagram is merely an example, which should not unduly limit the scope of the claims defined herein. The method begins at a process operation shown by reference numeral 701. The method tests the network capacity. As merely an example, the method performs one or more tests. These tests are shown as follows.

### Network Tests

Bandwidth availability

Network elements up and running

Network latency

Client status

Client capacity to receive (e.g., memory full or empty)

In a specific embodiment, the method determines if the network is able to receive messages, step 701. At the next step , the method retrieve the maximum number of messages allowed for this period of time. Next, the method analyzes the errors reported by the previously sent messages, step 703. As shown below, we have selected certain error reports.

### Example of Error Reports

Resource limitation;

Service completion failure;

No response from the peer;

Invalid response from the peer;

System failure;

Not supported service;

Data missing;

User not found;

Handover problem;

Operation and maintenance problem;

Busy user;

Call barred;

Memory capacity exceeded;

Congestion.

Next, the method determines if the network has the capacity required to send messages 704. The next process is to communicate the network capacity 705. Depending upon the embodiment, there can be a variety of processing operations for each of the messages. Some of these processing operations depend upon the status and the type of network among other factors.

These and other steps can be provided in the present method, which can be combined with any one or more of the methods described herein as well as others. The above figure describes aspects of the invention illustrated by elements in a simplified flow diagram. As will be understood by one of ordinary skill in the art, the elements can be implemented other ways. The method is preferably implemented in computer software. The elements can also be implemented in computer hardware. Alternatively, the elements can be implemented in a combination of computer hardware and software. Some of the elements may be integrated with other software and/or hardware, or specialized hardware (e.g. an ASIC). Alternatively, some of the elements may be combined together or even separated. These and other variations, modifications, and alternatives will be apparent by one of ordinary skill in the art.

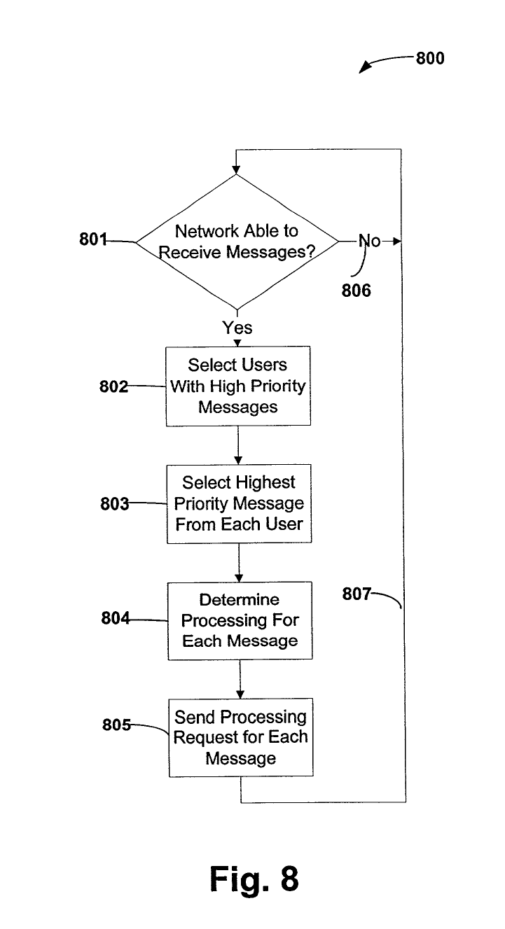

FIG. 8 shows a decision support method according to an embodiment of the present invention. Such method may be outlined as follows:

1. Receive the network capacity;

2. If network is able to receive messages, continue to next step, alternatively return to step (1);

3. Select the number of messages from each queue to be processed;

4. Determine processing operation for each of the messages of the selected users;

5. Performing processing operation for each of the messages;

6. Send processing request for each of the messages;

7. Return to step (1) and/or;

8. Perform other steps, as desired.

The above sequence of steps is merely an example of a way to carry out the present invention. As shown, these steps provide a way of processing pending message requests. In some embodiments, depending upon the status of the network, messages are processed accordingly. After that, the method goes on to perform other steps. One of these steps would be to transfer the message to a selected mobile communication device through a wireless network. Further details of these steps are provided throughout the present specification and more particularly below.

Referring to FIG. 8, the present method provides a simplified flow diagram (800) to illustrate a process of selecting messages to be sent to the network. As noted, this diagram is merely an example, which should not unduly limit the scope of the claims defined herein. The method begins at a process operation shown by reference numeral 801. The method receives the network capacity sent by the Decision Support Module. If there is no capacity, the method continues through branch 806 back to the element identified by reference numeral 801. Alternatively, the method goes onto step 802. Here, the method selects the number of messages from each queue to be processed;

As shown below, we have selected certain parameters to decide which messages have the highest priority.User SLA

Sender SLA

Application/service type

Time spent by the messages waiting in our queues

Time delay since delivery was scheduled

Time left before the end of the delivery period

Time of day

Number of delivery error reports

Next, the method determines a processing operation for each of the selected messages, step with were 804. Depending upon the embodiment, there can be a variety of processing operations for each of the messages. Some of these processing operations depend upon the status of the network among other factors. The following table below illustrates a few of these processing operations.

### Processing Operations

sending

waiting

killing

replacing

delaying

grouping

prioritizing

scheduling

filtering

Once the processing operation has been selected, the present method sends the processing requests for each message. This step is shown by reference numeral 805. Once the method has been executed, the method loops back via branch 807 to process element 801, where the entire method starts again. These and other steps can be provided in the present method, which can be combined with any one or more of the methods described herein as well as others.

The above figure describes aspects of the invention illustrated by elements in a simplified flow diagram. As will be understood by one of ordinary skill in the art, the elements can be implemented other ways. The method is preferably implemented in computer software. The elements can also be implemented in computer hardware. Alternatively, the elements can be implemented in a combination of computer hardware and software. Some of the elements may be integrated with other software and/or hardware, or specialized hardware (e.g. an ASIC). Alternatively, some of the elements may be combined together or even separated. These and other variations, modifications, and alternatives will be apparent by one of ordinary skill in the art. Further details of methods according to embodiments of the present invention can be found throughout the present specification and more particularly below.

A method according to an alternative embodiment of the present invention may be outlined as follows:

1. Receive a plurality of messages from more than one user;

2. Categorize the messages based upon more than one predetermined categories;

3. Sort each of the messages based upon the categories;

4. Select the message based upon the sort and other parameters (e.g., policy, network status);

4. Process each of the messages based upon the sort; and

5. Perform other steps, as desired.

The above sequence of steps is merely an example of a way to carry out the present invention. As shown, these steps provide a way of categorizing messages based upon predetermined categories. The message is then processed based upon a selected way of sorting them. After that, the method goes on to perform other steps. One of these steps would be to transfer the message to a selected mobile communication device through a wireless network.

While the above is a full description of the specific embodiments, various modifications, alternative constructions and equivalents may be used. Therefore, the above description and illustrations should not be taken as limiting the scope of the present invention which is defined by the appended claims.

What is claimed is:

1. A method for processing and delivering one or more messages for distribution over wireless networks, the method comprising:
receiving a message from a data network by a policy manager coupled between the data network and a wireless network;
parsing the message to identify selected information in the message for delivery of that message to a selected user of a wireless client device;
determining a processing decision for the message based upon at least the selected information and predetermined information of the policy manager while storing the message during a portion of time as the processing decision is determined; and
performing the processing decision for delivery of the message through the wireless network to the wireless client device.

2. The method of claim 1 wherein processing is selected from a sending, waiting, killing, replacing, delaying, grouping, prioritizing, scheduling, or filtering.

3. The method of claim 1 wherein the message is defined as data provided from the source to the destination.

4. The method of claim 1 wherein the message is selected from an e-mail message, an SMS message, an instant message, a chat message, a voice message, an alert a video message, a picture, a map, an MP3 file, or a drawing.

5. The method of claim 1 wherein the message is received by an input handler in the policy manager.

6. The method of claim 1 wherein the processing decision is based upon external information and internal information.

7. The method of claim 1 further comprising transferring the message to the wireless client device based upon the processing decision.

8. The method of claim 1 wherein the receiving is provided by an input handler that receives the message and is coupled to the data network.

9. The method of claim 1 wherein the storing is on a cache device for temporary storage of the message.

10. The method of claim 1 wherein the performing is provided from an output handler, the output handler being coupled to the wireless network.

11. A system for policy based management of messages over wireless networks, the system comprising:
a data network, the data network including a source of messages;
a wireless network, the wireless network including a destination of messages;
a message policy manager coupled to the wireless network and coupled to the data network such that the policy manager is configured between the source of messages on the data network and the destination for the messages on the wireless network, the policy manager being capable of taking one of the messages and making a decision on (how and when) a processing operation for delivery of the one message to the wireless network.

12. The system of claim 11 wherein the messages are defined as data provided from the source to the destination.

13. The system of claim 11 wherein the message policy manager is distributed on one or more server devices, each of the server devices being coupled to a wide area network of computers.

14. The system of claim 11 wherein the wireless network configuration is selected from at least a cellular network or a paging network.

15. The system of claim 11 wherein the wireless network is a GSM, CDMA, GPRS, EDGE, TDMA, CDMA2000, WCDMA, IMT2000, Mobitex, CDPD, Datatek, Paknet, or Ardis.

16. The system of claim 11 wherein the source is selected from at least SMSC, WAP gateway, or MMSC (Multimedia Messaging Service Center).

17. The system of claim 11 wherein the message is selected from an e-mail message, an SMS message, an instant message, a chat message, a voice message, an alert, a video message, a picture, a map, an MP3, or a drawing.

18. The system of claim 11 wherein the decision is based upon at least a parameter selected from source information, destination information, data in the message, preferences of the user at the destination, status of one or more portions of the wireless network, accessibility of the user, roaming user, or carrier traffic shaping.

19. The system of claim 11 wherein the message policy manager comprises:
a parsing module coupled to the data network, the parsing module being configured to identify information in the message;
a policy engine coupled to the parsing module, the policy engine determines a processing decision for the message based upon the identified information from the parsing module;
a storage module coupled to the parsing module, the storage module being configured to store the message as the processing decision is performed; and
an enforcement module coupled to the policy engine and the storage module for performing the processing decision and providing an operation for delivery of the message to through the wireless network.

20. The system of claim 19 further comprising a decision support module coupled to the policy engine and the wireless network, the decision support module receives network status information and/or user information from the wireless network, the information being provided to the policy engine for determining the processing decision.

21. The system of claim 1 1 wherein the message policy manager comprises:
a policy engine, the policy engine determines a processing decision for one or more of the messages; and
a storage module coupled to the policy engine, the storage module including an input handler for receiving the messages and an output handler for processing and delivering messages and a message cache coupled between the input handler and the output handler, the cache being configured to store one or more of the messages as the processing decision is performed.
